(19) United States
(12) Patent Application Publication
(10) Pub. No.: US 2002/0140493 A1
(43) Pub. Date: Oct. 3, 2002

(54) CMOS output circuit

(76) Inventor: Ryohei Kimura, Chiba-shi (JP)

Correspondence Address: ADAMS & WILKS, 31st Floor, 50 Broadway, New York, NY, 10004, US

(21) Appl. No.: 10/076,745

(22) Filed: Feb. 14, 2002

(30) Foreign Application Priority Data
Mar. 27, 2001 (JP) 2001-090606

(51) Int. Cl. H01H 37/76

(52) U.S. Cl. 327/525

(57) ABSTRACT

A circuit in which an output at the time of shutdown is selected by a certain method. A switch element is connected between a gate of a transistor in an output stage and a terminal having a potential of a VDD or VSS level to select a gate potential.

### BACKGROUND OF THE INVENTION

1. Field of the Invention

The present invention relates to a complementary metal-oxide semiconductor (CMOS) circuit for determining an output at the time of shutdown.

2. Description of the Related Art

FIG. 4 shows an example of a conventional CMOS output circuit. The operation of the conventional CMOS output circuit will be described with reference to FIG. 4. A gate terminal of a PMOS transistor 414 is connected to an input terminal 403, and a gate terminal of an NMOS transistor 411 is connected to an input terminal 402. The voltage at an output terminal 401 is determined by the operating currents of the PMOS transistor 414 and NMOS transistor 411. When a shutdown signal 422 is input to the gate of a PMOS transistor 413, the PMOS transistor 413 is turned on to pull the potential at the terminal 403 to VDD, thereby turning off the PMOS transistor 414. Similarly, the input of a shutdown signal 421 causes the NMOS transistor 411 to be turned off to limit the current of the CMOS output circuit. At this time, the impedance at the output terminal 401 is high.

In the conventional CMOS output circuit, an output can be obtained with a high impedance or the output voltage can be pulled to VSS or VDD. To enable selection of each output state, however, it is necessary to change the circuit and to use separate fabrication processes.

### SUMMARY OF THE INVENTION

An object of the present invention is to provide a CMOS output circuit capable of selecting one of an output with a high impedance, VSS, and VDD without the above-described problem.

A CMOS output circuit in accordance with the present invention uses a switch for selectively pulling to VDD or VSS the potential of each of gates of a PMOS transistor and an NMOS transistor which determine an output voltage at the time of shutdown. An output from the thus-formed CMOS output circuit can be determined as an output with a high impedance, VSS, or VDD by selecting the state of the switch.

### BRIEF DESCRIPTION OF THE DRAWING

In the accompanying drawings:

FIG. 1 is a diagram showing the configuration of a CMOS output circuit in accordance with the present invention;

FIG. 2 is a diagram showing the configuration of a CMOS output circuit in accordance with the present invention;

FIG. 3 is a diagram showing the configuration of a CMOS output circuit in accordance with the present invention;

FIG. 4 is a diagram showing the configuration of a conventional CMOS output circuit;

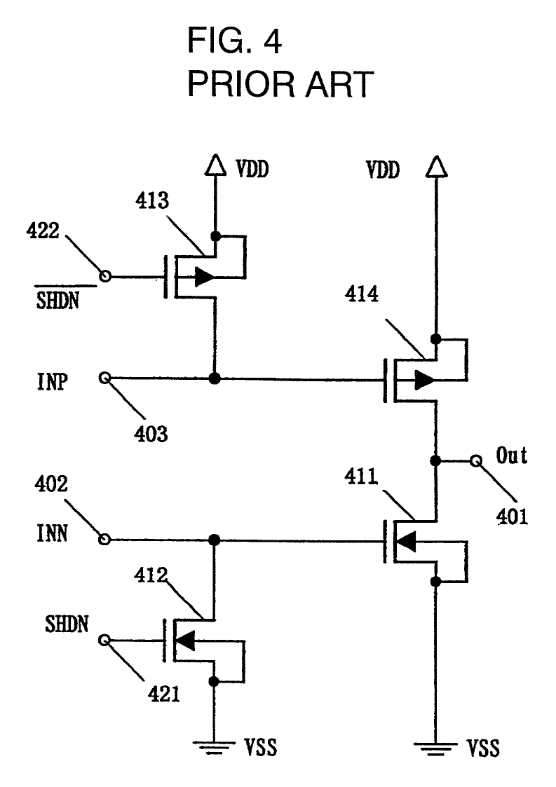

FIG. 5 is a diagram showing a CMOS output circuit in accordance with the present invention in an opposite-phase relationship with the circuit shown in FIG. 1; and

FIG. 6 is a diagram showing a CMOS output circuit in accordance with the present invention in an opposite-phase relationship with the circuit shown in FIG. 2.

### DESCRIPTION OF THE PREFERRED EMBODIMENTS

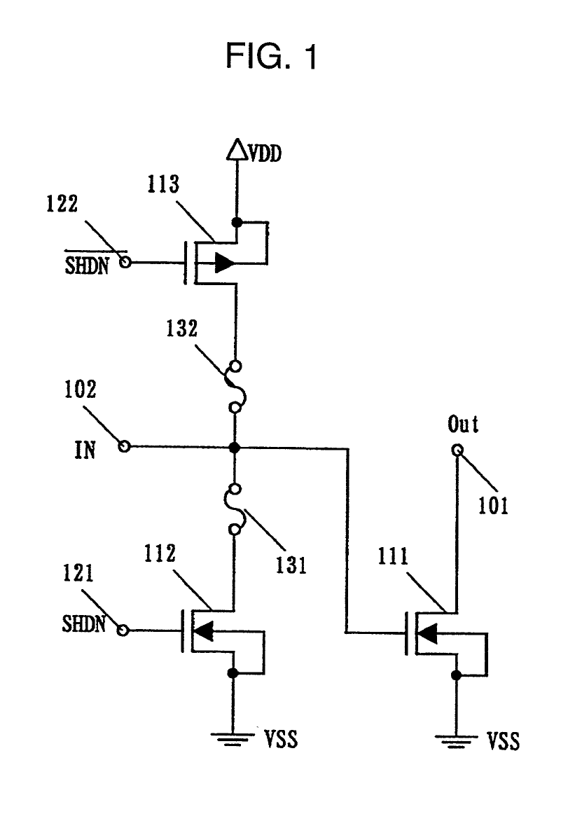

Embodiments of the present invention will be described with reference to the accompanying drawings. FIGS. 1, 2, 3, 5, and 6 are diagrams showing examples of CMOS output circuits in accordance with the present invention.

Referring to FIG. 1, an input terminal 102 is connected to a gate of an NMOS transistor 111. The potential at an output terminal 101 is determined by the potential at the input terminal 102. When signals are input to shutdown terminals 121 and 122, an NMOS transistor 112 and a PMOS transistor 113 are turned on. If at this time a fuse 132 is broken while a fuse 131 conducts electricity, the gate potential of the NMOS transistor 111 is pulled to VSS to turn off the NMOS transistor 111, thereby setting a high impedance at the output terminal 101. Conversely, if the fuse 131 is broken while the fuse 132 conducts electricity, the gate potential of the NMOS transistor 111 is pulled to VDD to turn on the NMOS transistor 111, and the potential at the output terminal 101 is thus pulled to VSS. Thus, VSS or an output with a high impedance can be selected as an output at the time of shutdown by changing one of the fuses 131 and 132 between the conduction and broken states.

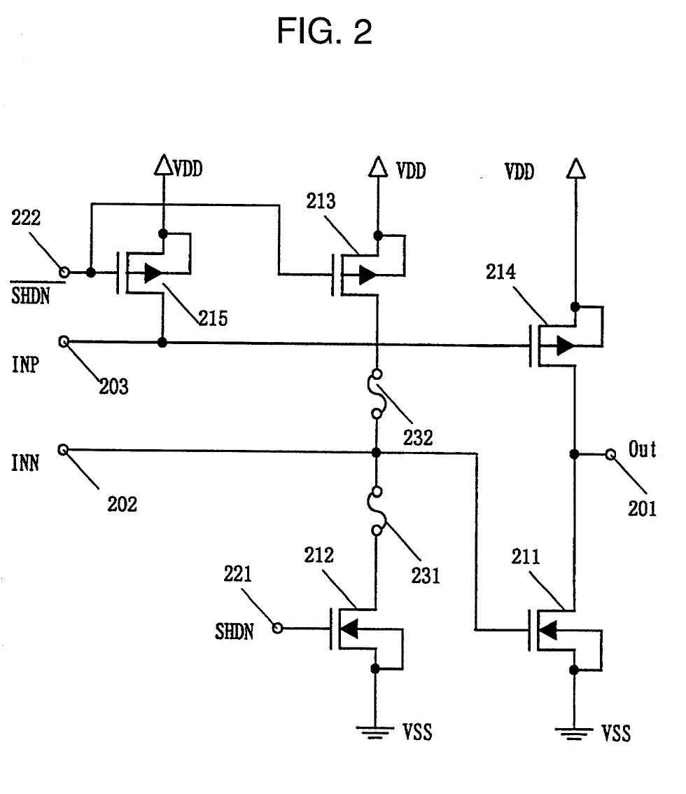

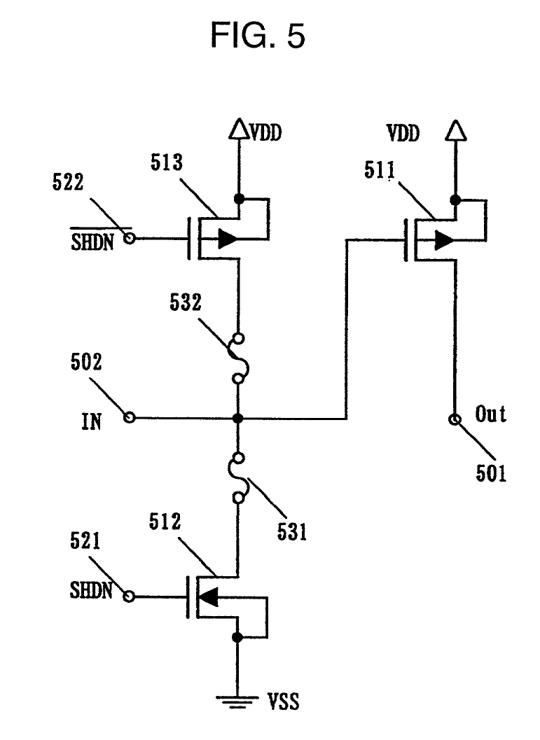

Similarly, an arrangement as shown in FIG. 5 in an opposite-phase relationship with that shown in FIG. 1 enables selection between VDD and an output with a high impedance. Next, the operation of a circuit shown in FIG. 2 will be described. Referring to FIG. 2, an input is supplied from an input terminal 202 to a gate of an NMOS transistor 211, and an input is supplied from an input terminal 203 to a gate of a PMOS transistor 214. The potential at an output terminal 201 is determined by currents flowing through the two transistors 211 and 214. When signals are input to shutdown terminals 221 and 222, an NMOS transistor 212 and PMOS transistors 213 and 215 are turned on to pull the gate potential of the PMOS transistor 214 to VDD, thereby turning off the PMOS transistor 214. If at this time a fuse 232 is broken while a fuse 231 conducts electricity, the gate potential of the NMOS transistor 211 is pulled to VSS to turn off the NMOS transistor 211, thereby setting a high impedance at the output terminal 201.

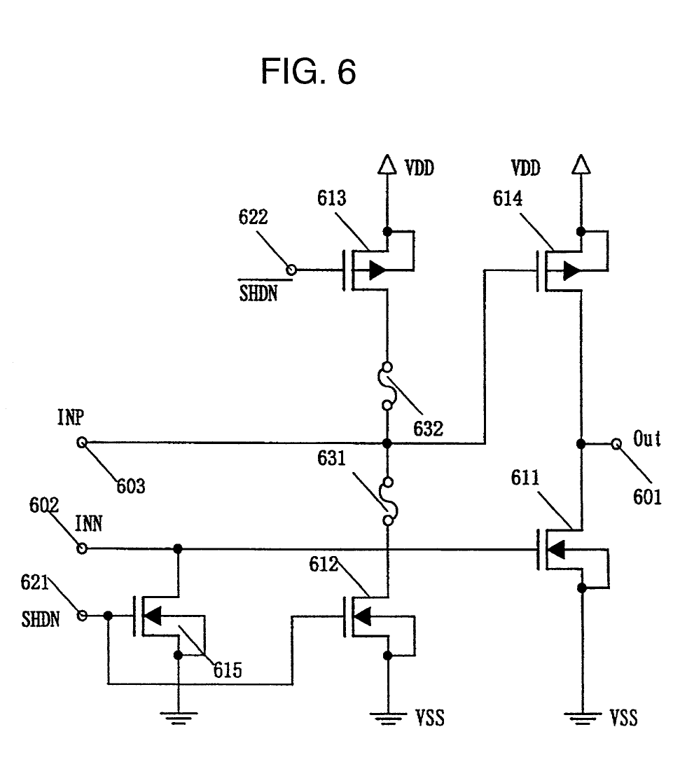

Conversely, if the fuse 231 is broken while the fuse 232 conducts electricity, the gate potential of the NMOS transistor 211 is pulled to VDD to turn on the NMOS transistor 211 and thus the potential at the output terminal 201 is pulled to VSS. Thus, VSS or an output with a high impedance can be selected as an output at the time of shutdown by changing one of the fuses 231 and 232 between the conduction and broken states. Similarly, an arrangement as shown in FIG. 6 in an opposite-phase relationship with that shown in FIG. 2 enables selection between VDD and an output with a high impedance.

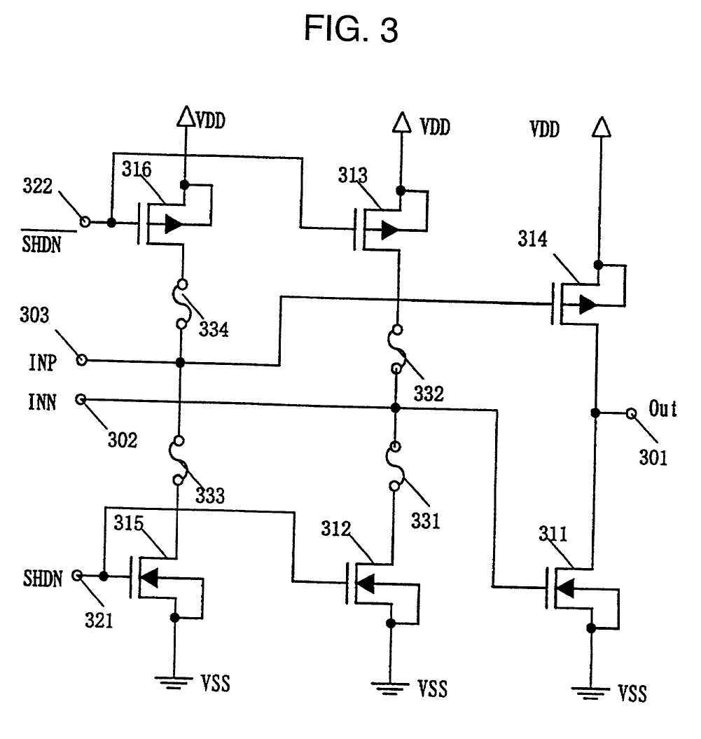

Next, the operation of a circuit shown in FIG. 3 will be described. Referring to FIG. 3, an input is supplied from an input terminal 302 to a gate of an NMOS transistor 311, and an input is supplied from an input terminal 303 to a gate of a PMOS transistor 314. The potential at the output terminal 301 is determined by currents flowing through the two transistors 311 and 314. When signals are input to shutdown terminals 321 and 322, NMOS transistors 312 and 315 and PMOS transistors 313 and 316 are turned on. If a fuse 332 is broken while a fuse 331 conducts electricity, the gate potential of the NMOS transistor 311 is pulled to VSS to turn off the NMOS transistor 311. If a fuse 333 is broken while a fuse 334 conducts electricity, the gate potential of the PMOS transistor 314 is pulled to VDD to turn off the NMOS transistor 314 and thus a high impedance at the output terminal 301 is set.. On the other hand, if the fuse 331 is broken while the fuse 332 conducts electricity, the gate potential of the NMOS transistor 311 is pulled to VDD to turn on the NMOS transistor 311. If the fuse 333 is broken while the fuse 334 conducts electricity, the gate potential of the PMOS transistor 314 is pulled to VDD to turn off the PMOS transistor 314 and thus the potential at the output terminal 301 is pulled to VSS. Conversely, if the fuse 332 is broken while the fuse 331 conducts electricity, the gate potential of the NMOS transistor 311 is pulled to VSS to turn off the NMOS transistor 311. If the fuse 334 is broken while the fuse 333 conducts electricity, the potential of the PMOS transistor 314 is pulled to VSS to turn on the PMOS transistor 314 and thus the potential at the output terminal 301 is pulled to VDD. Thus, one of VDD, VSS, and an output with a high impedance can be selected as an output at the time of shutdown by changing the fuses 331 to 334 between the conduction and broken states.

The fuses in the circuits shown in FIGS. 1, 2, 3, 5, and 6 may be switches capable of switching between on and off states and may also be replaced with nonvolatile memories.

The present invention is implemented in the form of each of the above-described embodiments and is advantageous as described below. The gate of each of the output side PMOS and NMOS transistors can be selectively pulled to VSS or VDD by a switch to select one of an output with a high impedance, VSS, and VDD. The selection may be changed after fabrication, depending on the type of the switch element.

What is claimed is:

1. A CMOS output circuit comprising:
a first MOS transistor having a first source terminal, a first gate terminal, and a first drain terminal;
a second MOS transistor having a second source terminal, a second gate terminal, and a second drain terminal, the second source terminal being connected to a negative power supply voltage VSS, the second gate terminal being connected to a first shutdown signal terminal;
a third MOS transistor having a third source terminal, a third gate terminal, and a third drain terminal, the third source terminal being connected to a positive power supply voltage VDD, the third gate terminal being connected to a second shutdown signal terminal;
a first switch element having its one end connected to the second drain terminal and having the other end connected to the first gate terminal; and
a second switch element having its one end connected to the third drain terminal and having the other end connected to a point of connection between the first gate terminal and the first switch element,
wherein the first source terminal is connected to one of the power supply voltages, and the first drain terminal is used as an output terminal.

2. A CMOS output circuit according to claim 1, wherein the first source terminal is connected to the negative power supply voltage VSS.

3. A CMOS output circuit according to claim 2, wherein each of said first and second MOS transistors is formed of an n-type MOS transistor, and wherein said third MOS transistor is formed of a p-type MOS transistor.

4. A CMOS output circuit according to claim 1, wherein the first source terminal is connected to the positive power supply voltage VDD.

5. A CMOS output circuit according to claim 4, wherein each of said first and third MOS transistors is formed of a p-type MOS transistor, and wherein said second MOS transistor is formed of an n-type MOS transistor.

6. A CMOS output circuit comprising:
a first MOS transistor having a first source terminal, a first gate terminal, and a first drain terminal, the first source terminal being connected to a negative power supply voltage VSS;
a second MOS transistor having a second source terminal, a second gate terminal, and a second drain terminal, the second source terminal being connected to the negative power supply voltage VSS, the second gate terminal being connected to a first shutdown signal terminal;
a third MOS transistor having a third source terminal, a third gate terminal, and a third drain terminal, the third source terminal being connected to a positive power supply voltage VDD, the third gate terminal being connected to a second shutdown signal terminal;
a fourth MOS transistor having a fourth source terminal, a fourth gate terminal, and a fourth drain terminal, the fourth source terminal being connected to the positive power supply voltage VDD, the fourth drain terminal being connected to the first drain terminal;
a fifth MOS transistor having a fifth source terminal, a fifth gate terminal, and a fifth drain terminal, the fifth source terminal, being connected to the positive power supply voltage VDD, the fifth gate terminal being connected to the third gate terminal, the fifth drain terminal being connected to the fourth gate terminal;
a first switch element having its one end connected to the second drain terminal and having the other end connected to the first gate terminal; and
a second switch element having its one end connected to the third drain terminal and having the other end connected to a point of connection between the first gate terminal and the first switch element,
wherein a point of connection between the fourth gate terminal and the fifth drain terminal is used as an input terminal, and a point of connection between the first drain terminal and the fourth drain terminal is used as an output terminal.

7. A CMOS output circuit according to claim 6, wherein each of said first and second MOS transistors is formed of an n-type MOS transistor, and wherein each of said third, fourth, and fifth MOS transistors is formed of a p-type MOS transistor.

8. A CMOS output circuit comprising:
a first MOS transistor having a first source terminal, a first gate terminal, and a first drain terminal, the first source terminal being connected to a positive power supply voltage VDD;
a second MOS transistor having a second source terminal, a second gate terminal, and a second drain terminal, the second source terminal being connected to the positive power supply voltage VDD, the second gate terminal being connected to a first shutdown signal terminal;
a third MOS transistor having a third source terminal, a third gate terminal, and a third drain terminal, the third source terminal being connected to a negative power supply voltage VSS, the third gate terminal being connected to a second shutdown signal terminal;
a fourth MOS transistor having a fourth source terminal, a fourth gate terminal, and a fourth drain terminal, the fourth source terminal being connected to the negative power supply voltage VSS, the fourth drain terminal being connected to the first drain terminal;
a fifth MOS transistor having a fifth source terminal, a fifth gate terminal, and a fifth drain terminal, the fifth source terminal being connected to the negative power supply voltage VSS, the fifth gate terminal being connected to the third gate terminal, the fifth drain terminal being connected to the fourth gate terminal;
a first switch element having its one end connected to the second drain terminal and having the other end connected to the first gate terminal; and
a second switch element having its one end connected to the third drain terminal and having the other end connected to a point of connection between the first gate terminal and the first switch,
wherein a point of connection between the fourth gate terminal and the fifth drain terminal is used as an input terminal, and a point of connection between the first drain terminal and the fourth drain terminal is used as an output terminal.

9. A CMOS output circuit according to claim 8, wherein each of said first and second MOS transistors is formed of a p-type MOS transistor, and each of said third, fourth, and fifth MOS transistors is formed of an n-type MOS transistor.

10. A CMOS output circuit comprising:
a first MOS transistor having a first source terminal, a first gate terminal, and a first drain terminal, the first source terminal being connected to a negative power supply voltage VSS;
a second MOS transistor having a second source terminal, a second gate terminal, and a second drain terminal, the second source terminal being connected to the negative power supply voltage VSS, the second gate terminal being connected to a first shutdown signal terminal;
a third MOS transistor having a third source terminal, a third gate terminal, and a third drain terminal, the third source terminal being connected to a positive power supply voltage VDD, the third gate terminal being connected to a second shutdown signal terminal;
a fourth MOS transistor having a fourth source terminal, a fourth gate terminal, and a fourth drain terminal, the fourth source terminal being connected to the positive power supply voltage VDD, the fourth drain terminal being connected to the first drain terminal;
a fifth MOS transistor having a fifth source terminal, a fifth gate terminal, and a fifth drain terminal, the fifth source terminal being connected to the negative power supply voltage VSS, the fifth gate terminal being connected to the second gate terminal;
a sixth MOS transistor having a sixth source terminal, a sixth gate terminal, and a sixth drain terminal, the sixth source terminal being connected to the positive power supply voltage VDD, the sixth gate terminal being connected to the third gate terminal;
a first switch element having its one end connected to the second drain terminal and having the other end connected to the first gate terminal;
a second switch element having its one end connected to the third drain terminal and having the other end connected to a point of connection between the first gate terminal and the first switch element;
a third switch element having its one end connected to the fifth drain terminal and having the other end connected to the fourth gate terminal; and
a fourth switch element having its one end connected to the sixth drain terminal and having the other end connected to a point of connection between the fourth gate terminal and the third switch element,
wherein the first and fourth gate terminals are used as input terminals, and a point of connection between the first and fourth drain terminals is used as an output terminal.

11. A CMOS output circuit according to claim 10, wherein each of said first, second, and fifth MOS transistors is formed of an n-type MOS transistor, and wherein each of said third, fourth, and sixth MOS transistors is formed of a p-type MOS transistor.

12. A CMOS output circuit according to claim 1, wherein each of said first to fourth switch elements comprises a fuse.

13. A CMOS output circuit according to claim 1, wherein each of said first to fourth switch elements comprises a nonvolatile memory.
